(19) United States
(12) Patent Application Publication
(10) Pub. No.: US 2016/0109063 A1
(43) Pub. Date: Apr. 21, 2016

(54) APPARATUS AND METHOD TO FLUSH ESP MOTOR OIL

(71) Applicant: APACHE CORPORATION, Houston, TX (US)

(72) Inventor: Michael R. Berry, Houston, TX (US)

(73) Assignee: APACHE CORPORATION, Houston, TX (US)

(21) Appl. No.: 14/895,487

(22) PCT Filed: May 21, 2014
(86) PCT No.: PCT/US14/38899

§ 371 Date: Dec. 2, 2015

Related U.S. Application Data
(60) Provisional application No. 61/830,682, filed on Jun. 4, 2013.

(51) Int. Cl. F16N 31/00; H02K 9/193; H02K 5/132; E21B 43/12; F16N 19/00

(52) U.S. Cl. CPC F16N 31/00; E21B 43/128; F16N 19/00; H02K 5/132; H02K 9/193

(57) ABSTRACT

A motor oil change system for an electric submersible pump includes motor oil reservoir disposed proximate an electric motor used to drive a wellbore pump and means for selectively moving oil from the reservoir into the motor to displace oil present in the motor.

### BACKGROUND

This disclosure relates generally to the field of electrically operated submersible wellbore pumps. More specifically, the disclosure relates to methods and apparatus for replacement of lubricating oil for electric motors and motor protectors used in such pumps.

Electric submersible pumps (ESPs) are sometimes used in wellbores drilled through subsurface formations to life fluids from certain formations (e.g., hydrocarbon producing formations) when pressure of the fluid in the formation is insufficient to lift the produced fluids to the surface at desired production rates. One example of an ESP combined with a downhole oil/water separator (DOWS) is described in U.S. Pat. No. 7,828,058 issued to Fielder, although the present disclosure contemplates ESPs with or without a DOWS.

A typical ESP includes an electric motor, a motor protector and a pump rotationally coupled to the electric motor through the motor protector. The motor protector serves, among other functions, to exclude wellbore fluid from the electric motor while enabling rotational energy from the motor to be communicated to the pump. The ESP assembly is typically disposed in the wellbore at the end of a string of production tubing.

The electric motor is typically filled with lubricating oil. The oil may require changing at selected intervals in order to provide lubricant that is free of contamination that may pass through the protector, and has correct lubrication properties. Contamination and loss of lubrication properties may take place over time, thus require changing the oil in the electric motor and motor protector. Methods and devices known in the art for changing ESP oil include removing the entire tubing string and ESP, or using a capillary tube to pump new oil into a flush port in the motor or protector housing. This method presents difficulties because provisions must be made to run the capillary tube, which must be extremely clean and pre-filled with motor oil. This may be particularly problematic with complicated offshore or subsea installations. If the capillary tube is torn or a perforation worn into it during installation in long installations it can become a leak path for wellbore fluids to enter the electric motor. Furthermore, unless the capillary tube is run to the base of the electric motor, increasing the risk of damage, the motor oil may not be completely flushed.

### SUMMARY

A motor oil change system for an electric submersible pump in one aspect includes a motor oil reservoir disposed proximate an electric motor used to drive a wellbore pump and means for selectively moving oil from the reservoir into the motor to displace oil present in the motor.

A method for changing motor oil in an electric submersible wellbore pump according to another aspect includes at selected times, moving motor oil into a motor and motor protector on the wellbore pump from a reservoir proximate the motor. The moving motor oil displaces existing oil present in the pump and protector. The moving is performed until substantially all the existing oil is displaced into a wellbore by the moved oil.

Other aspects and advantages will be apparent from the following description and claims.

### BRIEF DESCRIPTION OF THE DRAWINGS

FIG. 1 is a schematic view of an example apparatus according to the disclosure.

### DETAILED DESCRIPTION

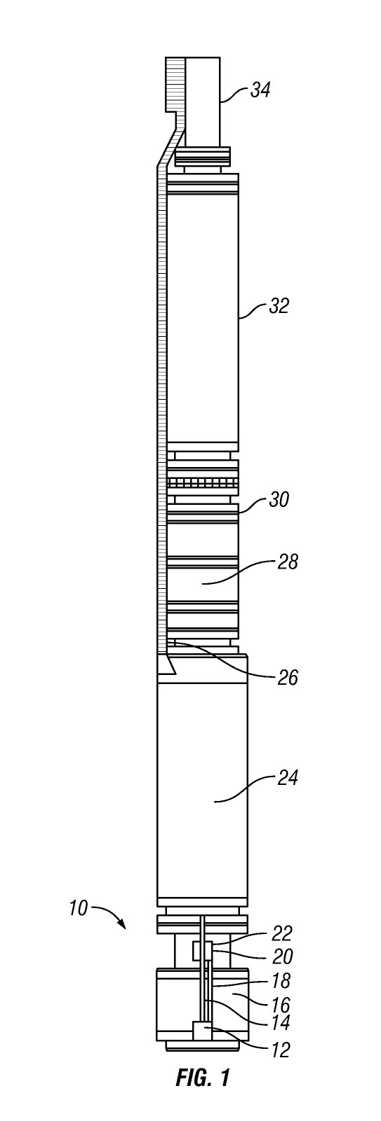

FIG. 1 shows an ESP oil flush system 10 forming part of an electric motor/ESP system disposable in a subsurface wellbore. The present example includes a motor driven pump 32 coupled to an end of a production tubing 34. The pump 32 may be operated by an electric motor 24 disposed below the pump 32. An electric power cable 26 transmits electric power from the surface to operate the motor 24 and may provide control signals to electronic control circuitry 20 on an enclosed circuit board 22.

The present example includes an oil reservoir 16 having a flush oil pump 12 in communication with the interior of the electric motor 24 through a flush oil pump 12 and a flush oil tube 14 coupled to the bottom of the motor 24. Such a reservoir 16 can easily be placed below the motor 24 as part of the insertion of the ESP system in the wellbore. Oil in the reservoir 16 can then be used to periodically flush the old oil out of the motor 24 and seal section (motor protector 28). A simple structure to flush the oil through the motor 24 would be to install a small electrically driven pump 12 in the oil reservoir 16. The pump 12 could be actuated via an electric circuit mounted on or with an ESP sensor electronics board 22. These sensors are typically installed at the base of the motor 20 and are powered by a DC signal imposed upon the AC power used to operate the motor 24.

The pressure in the oil reservoir 16 should be equalized with the wellbore fluid pressure to enable pumping the oil without the need to pump against wellbore fluid pressure. A simple structure to enable such pressure equalization may be to encase the oil (i.e., for the reservoir 16) in an elastomeric bag and vent an annular space between the inside of the oil reservoir housing and the outside of the bag to the wellbore. Alternatives include one or more pistons disposed in corresponding cylinder(s) or an inert gas pre-charge which could exceed the expected wellbore fluid pressure and corresponding internal motor oil pressure (and thus eliminate the need for a flush pump).

There are several possible structures for the flush oil pump 12. The pump 12 could be a centrifugal, gear, twin screw, or similar pump driven by an electric motor. The motor circuit could be completed via relays actuated via a signal sent from the surface over the ESP power cable 26. The motor could be powered, for example, by the DC signal that drives the ESP motor sensor 20, batteries or batteries charged by the DC signal that drives the ESP motor sensor 20 over a cable 18.

The flush oil pump 12 may also be a diaphragm and check valve arrangement to form a diaphragm pump (in some examples in conjunction with the reservoir bladder) that uses the wellbore pressure differential between static and pumping pressures to provide the energy to drive the fluid from the reservoir into the motor. In some examples there may be only one long, slow stroke per start/stop cycle which ends when maximum drawdown is reached. A relay circuit may be used to place an actuated valve in open or closed state in order to enable/disable the flush oil pump 12 and/or oil flush oil tube 14. Alternatively, every pressure cycle which exceeds the differential pressure through the motor 24 and protector 28 could provide a stroke, e.g., speeding up and slowing down the pump 12 rate using methods such as varying the input electrical power frequency or reducing the pumped rate by changing the orifice of a variable orifice choke could provide strokes.

Pre-pressurizing the flush oil reservoir with an inert gas to a pressure which exceeds the fluid pressure in the wellbore may be used in some examples to provide an oil flush mechanism which does not require a pump. Charge pressure must be such that the charged volume of gas will expand enough to displace the flush oil at somewhat above the expected wellbore pressure. This may eliminates the need for a pump (all that is needed is an actuated valve on the flush oil discharge line) or flush oil reservoir pressure equalization.

Motor oil flushes may be timed to take place immediately after a motor shutdown. The motor will not be rotating and the old oil in the motor will be at a higher temperature (and consequently a lower viscosity and density than the flush oil) thus facilitating more complete oil displacement with minimal mixing.

If more than one oil flush is desired, there must be a means to measure and/or control the volume of flush oil. this can be accomplished by:

(a) using multiple flush oil reservoir bags (multiple specifically sized reservoirs 16) with a manifold and control valve system coupled to the flush oil tube 14. If using an electrically driven pump, methods such as monitoring current, motor temperature and differential pressure through a restriction or a flow/no flow indicator can be used to indicate when the particular reservoir is empty;

(b) using a positive displacement pump and counting strokes/revolutions;

(c) using a battery driven pump, running the pump until the batteries are discharged at which point a timer which controls operation time of the subsequent oil flush can be reset and a battery recharge cycle can begin.

Reference to the foregoing timer and other control functions of the flush oil pump 12 and any other controlled apparatus associated with the flush oil pump 12 may be disposed proximate or with the sensor board 22 or other convenient location proximate the pump motor 24 and sensor 20.

The oil reservoir 16 may either be mounted at the base of the sensor board 22 or integrated into the sensor board 22. The flush oil pump 12 may be placed in the reservoir 16 with a discharge tube 14 that runs past the sensor electronics 20 and into the motor 24. A check valve (not shown) may be mounted in this flow path to prevent old motor oil from back flowing into the oil reservoir 16. The oil flush circuitry in the sensor/oil reserve could be activated via a signal from the surface, engaging a relay which starts the flush oil pump 12. As the flush oil is pumped through the ESP motor 24 and motor protector 28, the old oil may be discharged through the seal breather port 30 normally located in the head of the motor protector 28.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A motor oil change system for an electric submersible pump, comprising:
a motor oil reservoir disposed proximate an electric motor used to drive a wellbore pump; and
means for selectively moving oil from the reservoir into the motor to displace oil present in the motor and/or protector.

2. The system of claim 1 wherein the reservoir comprises at least one elastomeric bag exposed on its exterior to wellbore fluid pressure.

3. The system of claim 2 wherein the means for selectively moving comprises a pump.

4. The system of claim 3 wherein the pump comprises a positive displacement pump.

5. The system of claim 4 further comprising means for determining a volume of oil displaced by the positive displacement pump.

6. The system of claim 5 wherein the positive displacement pump comprises a piston pump, and the means for determining volume comprises a pump stroke counter coupled to the piston pump.

7. The system of claim 1 wherein the reservoir comprises at least one piston in a corresponding cylinder.

8. The system of claim 1 wherein the reservoir comprises a plurality of elastomeric bags each having a preselected amount of oil disposed therein, the plurality of bags coupled to a manifold configured to selectively fluidly couple one of the plurality of bags to the motor to enable a plurality of motor oil changes.

9. The system of claim 1 wherein the means for selectively moving comprises: a chamber having an internal pressure exceeding a fluid pressure in a wellbore wherein the wellbore pump is disposed, the at least one elastomeric bag disposed in the chamber; and a control valve to selectively hydraulically connect the elastomeric bag to the motor.

10. A method for changing motor oil in an electric submersible wellbore pump, comprising:
at selected times, moving motor oil into a motor and motor protector on the wellbore pump from a reservoir proximate the motor, the moving motor oil displacing existing oil present in the pump and protector;
wherein the moving is performed until substantially all the existing oil is displaced into a wellbore by the moved oil.

11. The method of claim 10 wherein the moving comprises operating a pump hydraulically disposed between the reservoir and the motor.

12. The method of claim 10 wherein the moving comprises controlling a volume of the moved oil.

13. The method of claim 12 wherein the controlling volume comprises selecting a predetermined volume for the reservoir.

14. The method of claim 12 wherein the controlling volume comprises operating a positive displacement pump for a preselected time interval or a selected number of pump strokes.

15. The method of claim 10 wherein the moving comprises pressurizing the reservoir above a fluid pressure proximate the wellbore pump and opening hydraulic passage between the reservoir and the motor.

16. The method of claim 15 wherein the reservoir comprises an elastomer bladder and the pressurizing comprises disposing the bladder in a chamber having pressurized gas therein.

17. The method of claim 15 wherein the reservoir comprises a piston in a cylinder.

18. The method of claim 10 wherein the selected times comprise time when the motor is switched off.
